(19) United States
(12) Patent Application Publication
(10) Pub. No.: US 2005/0262239 A1
(43) Pub. Date: Nov. 24, 2005

(54) Information update detection system

(75) Inventor: Yasuhiro Kawakita, Osaka (JP)

Correspondence Address: VENABLE LLP, P.O. BOX 34385, WASHINGTON, DC, 20045-9998, US

(73) Assignee: Oki Electric Industry Co., Ltd., Tokyo (JP)

(21) Appl. No.: 11/132,184

(22) Filed: May 19, 2005

(30) Foreign Application Priority Data
May 19, 2004 (JP) 2004-149343

(51) Int. Cl. G06F 15/173

(52) U.S. Cl. 709/224

(57) ABSTRACT

A detection target managing server configuring a Web page update detection system is arranged at the Internet. The update detection target managing server manages URL of data to be the update detection target for every user of the system and manages contact information of each user and a group to which each user belongs. An update detecting server is arranged in intranets connected to the Internet, accesses WWW server on the intranet and WWW servers on the Internet, in accordance with contents of database managed by the update detection target managing server and detects an update state of the Web page. Thus, the update state of the information shown in an internal network can be detected while saving costs for introduction and maintenance.

### CROSS REFERENCE TO RELATED APPLICATIONS

The disclosure of Japanese Patent Application No. JP2004-149343, filed on May 19, 2004, entitled “INFORMATION UPDATE DETECTION SYSTEM”. The contents of that application are incorporated herein by reference in their entirety.

### BACKGROUND OF THE INVENTION

The present invention relates to an information update detection system, which is, for example, applicable to a system for detecting an update of Web page designated by a user to notify a notified party designated by the user of the update content.

### DESCRIPTION OF THE RELATED ART

A conventional information update detection system disclosed in the following Japanese Patent Gazettes: U.S. Pat. Nos. 3,139,408; 3,062,104; and Japanese Patent Laid-open Publication No. 10-283281 has a function of monitoring documents provided by many WWW servers on the Internet, detecting an update of a specific document and notifying a system user registered in advance of the update.

By the way, many companies introduce various technologies used in the Internet into a network environment in the organization to establish an intranet in many cases, with the spread of the Internet. Using such a standard technology in the Internet as TCP/IP, WWW and DNS in the network in the organization saves a cost for software, improves reliability of network and improves affinity with the Internet.

A highly confidential document used only in each organization (hereafter, referred to as “in-house document”) is normally stored in a server on an intranet (hereafter, referred to as “intranet server”). The increase in number of the intranet server in each intranet and the increase in number of the in-house document stored in each intranet server oblige user to access many intranet servers frequently to confirm the update state of various in-house documents. This is an extremely burdensome operation and makes it necessary to provide a system for detecting the update state of in-house document automatically.

### SUMMARY OF THE INVENTION

A firewall for acquiring requests for communication from inside and outside of an organization and judging permission/inhibition of passage thereof in accordance with a predetermined security policy is generally provided between an intranet and an external network such as the Internet. Owing to this firewall, a specific service is selectively provided for the user of intranet and the security of the network in the organization is ensured. On the other hand, providing the firewall makes it hard for the information update detection system established in the Internet to detect the update state of in-house document stored in the intranet server.

In order to detect the update state of in-house document by using the conventional information update detection system established in the Internet, it is necessary to introduce a secure line such as VPN (Virtual Private Network) connecting each intranet to the information update detection system. However, it is also necessary to prepare an apparatus responding to this function so as to establish VPN, which leads to a higher cost. In addition, there is a matter of a compatibility of a VPN-response apparatus.

Establishing a system with the same configuration as the conventional information update detection system in the intranet, on the other hand, makes it possible to detect the update of in-house document without introducing a secure line. However, providing two systems inside and outside of the intranet respectively increases the cost and complicates operation and maintenance.

The present invention has been achieved in view of the aforementioned problems, and an object of the present invention is to provide a novel and improved information update detection system capable of detecting the update state of the information shown in an internal network with an access from the external network limited, while saving costs for introduction and maintenance.

According to first aspect of the present invention, to solve the above problems, there is provided an information update detection system comprising: an update detection target managing means arranged at an external network (for example, the Internet) and managing a storage place of one or more pieces of internal information stored in an internal information storing means (for example, WWW server) arranged at an internal network (for example, intranet) with an access from the external network limited; and an update detecting means arranged at an internal network and detecting an update state of the one or more pieces of internal information the storage place of which is managed by the update detection target managing means. According to this system, arrangement of the update detecting means at the internal network facilitates the update notification of internal information. Also, arrangement of the update detection target managing means at the external network makes it possible to manage the update detection target managing means through the external network. Therefore, the maintenance of system becomes facilitated.

When a plurality of internal networks exist, it is preferable to detect the update state of the internal information provided in each internal network by arranging the update detecting means in each internal network. This configuration makes it possible to manage and operate the update detecting means for each internal network to realize the reduction of cost for maintenance. Even when a plurality of update detecting means exist, only one update detection target managing means can cope with since the update detection target managing means is arranged at the external network to which each update detecting means can access. Therefore, it is possible to save the cost for establishing the system.

Preferably, the update detection target managing means manages a user code assigned to each user and manages the storage place of the internal information in units of the user code. Also preferably, the update detection target managing means manages one or more notified parties for every user code and the update detecting means detects the update state of the internal information and notifies the notified party of a corresponding detection result. Thereby it becomes possible for the system user to perceive the update state of specific information reliably.

It is also applicable to provide a charging means for calculating the usage fee for system. It is preferable for the charging means to calculate the fee, based on one of: multiplication of the number of storage place of the internal information (or external information) and unit price; multiplication of the number of the user code and unit price; and multiplication of the number of notified parties and unit price, which are managed by the update detection target managing means. In addition, it is applicable to adopt what is called pay-as-you-go system in which only the amount exceeding a base number set for each number mentioned above is charged. It is also applicable to charge the combination of a flat-rate fee set for the base number and the pay-as-you-go system.

Further preferably, the update detection target managing means manages a storage place of one or more pieces of external information stored in an external information storing means (for example, WWW server) arranged at an external network, and the update detecting means detects the update state of the one or more pieces of external information the storage place of which is managed by the update detection target managing means. This configuration makes it possible for the update detecting means to detect both update states of the internal information and the external information.

According to second aspect of the present invention, to solve the above problems, there is provided an information update detection system comprising: an update detection target managing means arranged at an external network, managing a storage place of one or more pieces of internal information stored in an internal information storing means arranged at an internal network with an access from the external network limited and managing a storage place of one or more pieces of external information stored in an external information storing means arranged at an external network; an internal update detecting means arranged at an internal network and detecting an update state of the one or more pieces of internal information the storage place of which is managed by the update detection target managing means; and an external update detecting means arranged at an external network and detecting an update state of the one or more pieces of external information the storage place of which is managed by the update detection target managing means. According to this system, arrangement of the internal update detecting means at the internal network facilitates the update notification of internal information while arrangement of the external update detecting means at the external network facilitates the update notification of external information. Also, arrangement of the update detection target managing means at the external network makes it possible to manage the update detection target managing means through the external network as well as the internal network. Therefore, the maintenance of system becomes facilitated.

According to the present invention, it is possible to detect the update state of the information provided for the internal network reliably while saving initial cost for establishing the system and running cost for management and operation.

### BRIEF DESCRIPTION OF THE DRAWINGS

The above and other features of the invention and the concomitant advantages will be better understood and appreciated by persons skilled in the field to which the invention pertains in view of the following description given in conjunction with the accompanying drawings which illustrate preferred embodiments.

FIG. 1 is a block diagram showing the first embodiment of the present invention.

FIG. 2 is an explanatory diagram showing a configuration of data managed by a detection target managing server in the first embodiment.

FIG. 3 is a block diagram showing the second embodiment of the present invention.

### DETAILED DESCRIPTION OF THE PREFERRED EMBODIMENTS

Hereinafter, the preferred embodiment of the present invention will be described in reference to the accompanying drawings. Same reference numerals are attached to components having same functions in following description and the accompanying drawings, and a description thereof is omitted.

### First Embodiment

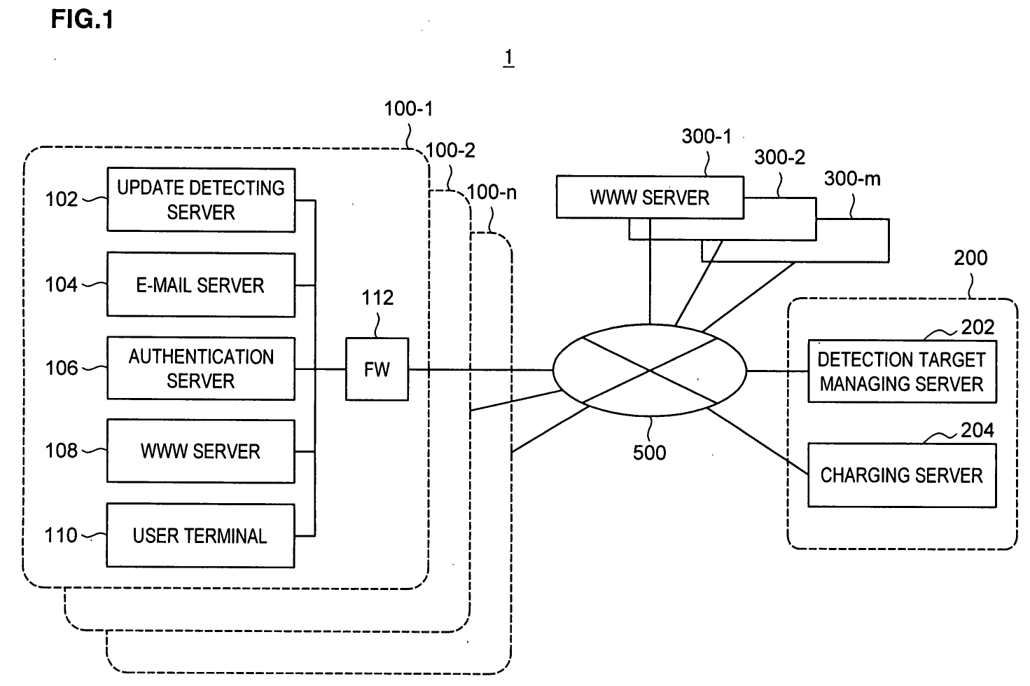

FIG. 1 shows a configuration of a Web page update detection system 1 (an information update detection system) in the first embodiment of the present invention. A detection target managing server 202 (an update detection target managing means) configuring the Web page update detection system 1 is arranged at the Internet 500. A plurality of WWW servers 300-1 to 300-m participate in the Internet 500 and a plurality of intranets 100-1 to 100-n are connected to the Internet 500. This embodiment will be described by referring to an example that a plurality of companies using the Web page update detection system 1 manage and operate each of the intranets 100-1 to 100-n. Although each company using the Web page update detection system 1 can manage and operate the detection target managing server 202, it is assumed that another ASP (Application Service Provider) 200 manages and operates the detection target managing server 202 in this embodiment.

Each of the intranets 100-1 to 100-n has almost the same main configuration, and the configuration of the intranet 100-1 will be described as a representative of this embodiment. The intranet 100-1 comprises: an update detecting server 102 (an update detecting means) configuring the Web page update detection system 1; an e-mail server 104; an authentication server 106; a WWW server 108 (an internal information storing means); a user terminal 110; and a firewall 112. Although only one WWW server 108 and one user terminal 110 are shown in the intranet 100-1 in FIG. 1, the intranet 100-1 may include a plurality of WWW servers and a plurality of user terminals.

The update detecting server 102 accesses the WWW server 108 on the intranet 100-1 and WWW servers 300-1 to 300-m on the Internet 500 to store a Web page in a cache. When the update detecting server 102 accesses the updated Web page, the update detecting server 102 detects the update to generate difference data corresponding to the updated content and notifies a specific user of the fact and content of the update.

The e-mail server 104 manages the exchange of e-mail of user belonging to the intranet 100-1. The authentication server 106 checks whether the user trying to log onto the intranet 100-1 is authorized to access or not in order to realize the function of security of the intranet 100-1. The WWW server 108 provides mainly the user belonging to the intranet 100-1 with a highly confidential Web page (internal information). The user terminal 110 is used by the user belonging to the intranet 100-1 and comprised by a personal computer, a PDA (Personal Digital Assistant) and so on. The firewall 112 is arranged at a connection node between the intranet 100-1 and the Internet 500 and prevents unauthorized access from the Internet 500 to the intranet 100-1. In addition, the firewall 112 can limit an access from the intranet 100-1 to the Internet 500 in accordance with a specific security policy.

The update detection target managing server 202 on the Internet 500 manages the storage place (URL: Uniform Resource Locator) of data (Web page) to be the update detection target for every user of the system 1 (user of the user terminal 110), and manages contact information of each user (e-mail address, phone number and so on) and a group to which each user belongs (company, school and other groups). In this embodiment, each of the intranets 100-1 to 100-n is registered in the detection target managing server 202 as one group and managed.

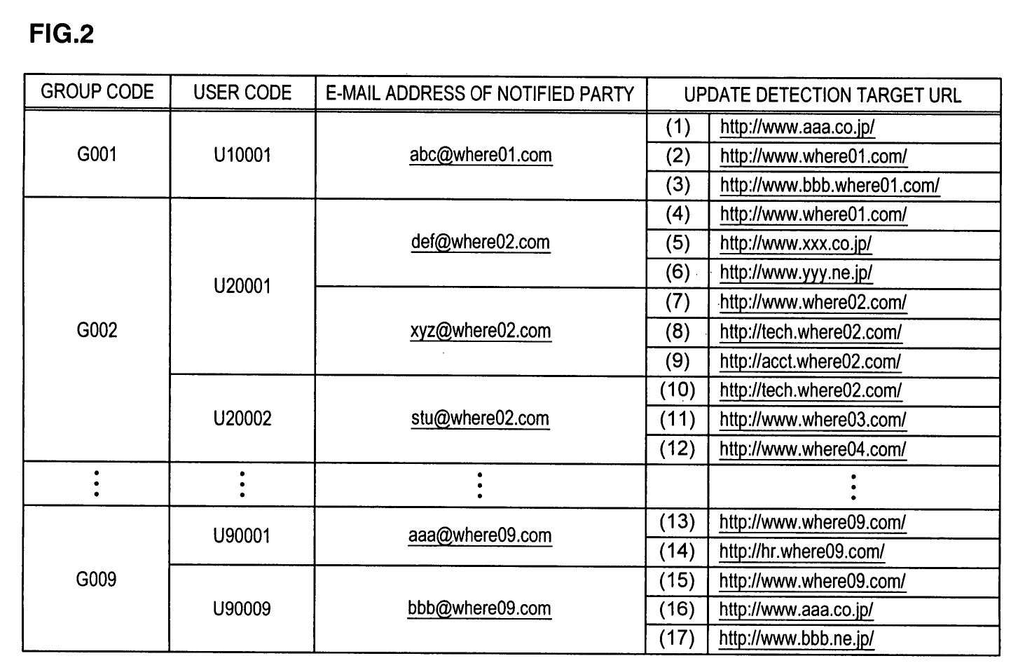

FIG. 2 shows a configuration of data managed by the detection target managing server 202. The detection target managing server 202 assigns a unique user code in the system 1 for each user of the system 1 and a unique group code in the system 1 for a group to which each user belongs to manage the user for every group.

The user of the system 1 can add each record shown in FIG. 2 as an initial registration, change and delete the record by operating the user terminal 100 to access the detection target managing server 202. At this time, the detection target managing server 202 sends data of setting screen of each record to the user terminal 110. The user adds the record as an initial registration in accordance with the screen display of user terminal 110. For example in this embodiment as shown in FIG. 2, the user belonging to a group with a group code “G001” assigned, and being assigned a user code “U10001” is assigned accesses the detection target managing server 202 to register an e-mail address “abc@where01.com” as contact information. Further the user registers “http://www.aaa.co.jp/”, “http://www.where01.com/” and “http://www.bbb.where01.com/” in the detection target managing server 202 as URL of data to be the update detection target.

Further the detection target managing server 202 has a charging function of calculating the usage fee for the system 1 to charge each user or each group for the usage fee. For example, the detection target managing server 202 counts the number of user (or the number of contact information) registered for every group, calculates the fee by multiplying the number of user (or the number of contact information) by a unit price and charges each group. The detection target managing server 202 may count the number of URL to be the update detection target and which is registered for every group, calculate the fee by multiplying the number of URL by a unit price and charge each group. In addition, it is preferable to set base numbers of registered user and registered URL for every group and to charge each group for only a basic charge in the case that the numbers are the base number or less and for a fee in accordance with the number over the base number in addition to the basic charge. It is preferable to charge regularly (for example, once a month). Note that it is applicable to arrange a charging server 204 having such a charging function on the Internet 500, which reduces the load of the detection target managing server 202.

The operation of the Web page update detection system 1 in this embodiment as configured above will be described. The operation of the system 1 is classified broadly into information registration operation in the detection target managing server 202 and update notification operation by the update detecting server 102.

[Information Registration Operation]

First, operators of each of the intranets 100-1 to 100-n apply to the ASP 200 managing and operating the detection target managing server 202 for the usage of the system 1. In response to this application, group codes assigned to each of the intranets 100-1 to 100-n in the detection target managing server 202. As a result, the user using each of the intranets 100-1 to 100-n is allowed to use the system 1. However, each user has to register as a user by using the user terminal 110 to access the detection target managing server 202 in order to use the system 1.

Before accessing the detection target managing server 202 by using the user terminal 110, the user is authenticated by the authentication server 106. For example, the authentication server 106 authenticates that the user is a staff of company managing and operating the intranet 100-1 to issue a unique user code for the user. In this embodiment, although the authentication server 106 issues the user code, a code issuing server for issuing the user code may be provided separately.

Next, the user accesses the detection target managing server 202 by using the user terminal 110. At this time, the user code and the group code are sent from the user terminal 110 to the detection target managing server 202, which permits access from the user terminal 110 based on the user code and the group code. Further, it is applicable to restrict access based on IP address and domain name on the Internet 500 side of the firewall 112. In addition, it is preferable to use a protocol with such a security function as SSL (Secure Sockets Layer) added for communication between the user terminal 110 and the detection target managing server 202, which saves the cost for communication and improves the communication safety.

Each user, as described above, registers the contact information (e-mail address) and the URL to be the update detection target in the detection target managing server 202. In order to facilitate this operation, the detection target managing server 202 sends the data of screen for registration to the user terminal 110. The user terminal 110 receives this data of screen for registration to display the screen for registration on a monitor. When the user accesses the detection target managing server 202 first, a screen for initial registration is displayed. On the other hand, when the user has already accessed the detection target managing server 202 and registered the contact information and the URL to be the update detection target, there is displayed an information on the user registered in the detection target managing server 202 on the monitor of user terminal 110. The user confirms the registered information displayed to register initial information, change and delete the registered information. The information registered in the detection target managing server 202 includes at least the contact information of user and the URL to be the update detection target, as shown in FIG. 2. In addition, each user may specify the validity of each record, the timing of update detection and the timing of notifying the user. Further, the target of update detection may be the data which is not disclosed as a Web page (for example, program code, voice data, image data and so on). It is also preferable to be capable of specifying a directory including not only one file but also a plurality of files as the target of update detection.

When the registration of specific information in the detection target managing server 202 is completed, the user may disconnect between the user terminal 110 and the detection target managing server 202. Each user waits for an update notification from the update detecting server 102.

[Update Notification Operation]

The update detecting server 102 starts up regularly to access the detection target managing server 202. Since the information stored in the detection target managing server 202 includes personal information on each user, it is preferable to use a protocol with a security function added for communication between the update detecting server 102 and the detection target managing server 202.

The update detecting server 102 creates a list of URL to be the update detection target for every user code registered. Since the update detecting server 102, at this time, belongs to the intranet 100-1, the update detecting server 102 creates a list including a record related to the group code “G001” assigned to the intranet 100-1. The update detecting server 102 accesses the WWW server 108 belonging to the same network (intranet 100-1) and the WWW servers 300-1 to 300-m participating in the Internet 500, in accordance with this list to confirm the update state of the Web page specified by the user.

The update detecting server 102 stores all source files of the Web page accessed first in the cache while creating difference data from the cache data on the Web page which has ever been accessed to update the cache data. Any method is applicable to create the difference data.

When the update detecting server 102 has detected the update state of the Web page of the URL to be the update detection target and which is related to a certain user code, the update detecting server 102 sends the detection result to the contact information (e-mail address) related to this user code. Note that the update detecting server 102 can detect the update of Web page and send the update detection result to each e-mail address for a plurality of user codes in parallel.

In the Web page update detection system 1, as described above, the update detecting server 102 and the detection target managing server 202 which are main components for the system 1 are separately arranged inside and outside of the intranets 100-1 to 100-n respectively. In other words, the update detecting server 102 is arranged inside the intranet 100 in order to detect the update state of the Web page managed by the WWW server 108 in the intranet 100 while the detection target managing server 202 accessed from each update detecting server 102 arranged at the intranet 100 is arranged on the Internet 500. This configuration allows the company managing and operating each of the intranets 100-1 to 100-n to introduce only the update detecting server 102 to its own network and makes it possible to save the cost for introducing the system.

The ASP 200, on the other hand, manages and operates the detection target managing server 202 by itself and provides each company with only the update detecting server 102, which reduces the cost for supporting each company. Robust establishment of the database system of the detection target managing server 202 makes it possible to maintain various types of information registered by each user in an integrated fashion and, as a result, to save the cost for maintenance of whole of the system 1.

Also in the system 1, the update detecting server 102 stores the copy of a specific Web page in the cache. Therefore, even in case that failures occur in the update detecting server 102, the original Web page, which is stored in each WWW server, is not lost.

Further, the ASP 200 can provide each company with the update detecting server 102 in the system 1 as an appliance server. The update detecting server 102, at this time, can be configured by hardware with software incorporated or only by software. The ASP 200 may provide each company with the update detecting server 102 free of charge or for rental or lease.

### Second Embodiment

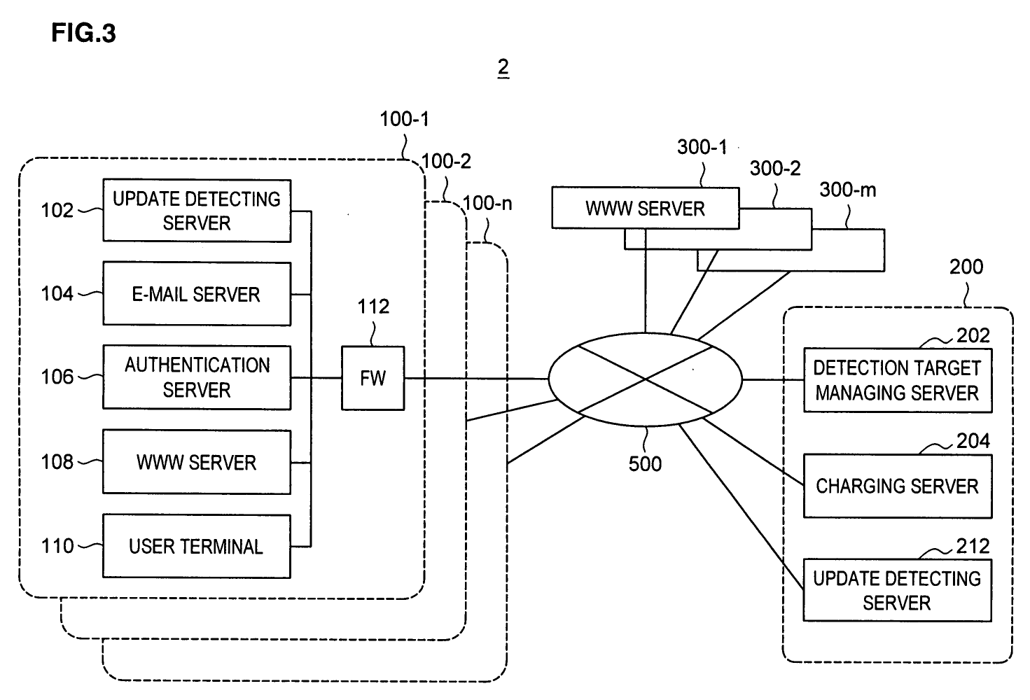

FIG. 3 shows a configuration of a Web page update detection system 2 (an information update detection system) in the second embodiment of the present invention. In this Web page update detection system 2, an update detecting server 212 (external update detecting means) is added to the Web page update detection system 1 in the first embodiment.

In the Web page update detection system 2 in the second embodiment, an update detecting server 102 (an internal update detecting means) arranged in an intranet 100-1 detects the update of Web page (internal information) stored in a WWW server 108 arranged in the intranet 100-1. The update detecting server 212 arranged on the Internet 500 detects the update of Web page (external information) stored in WWW servers 300-1 to 300-m participating in the Internet 500.

According to the Web page update detection system 1 in the first embodiment, at least n of update detecting servers 102 arranged at each of the intranets 100-1 to 100-n access the WWW servers 300-1 to 300-m arranged on the Internet 500 as well as the WWW server 108 in each of the intranets 100-1 to 100-n. According to the Web page update detection system 2 in the this embodiment, on the other hand, one update detecting server 212 arranged on the Internet 500 accesses a plurality of WWW servers 300-1 to 300-m, which detect the update of Web page provided to the Internet 500. Especially when a plurality of users belonging to each company (intranets 100-1 to 100-n) specify the same Web page on the Internet 500 as the update detection target, adopting the Web page update detection system 2 in the this embodiment makes it possible to detect the update state of each Web page effectively and to notify each user.

Next, the operation of the Web page update detection system 2 in this embodiment will be described. The operation of the system 2 is classified broadly into information registration operation in the detection target managing server 202 and update notification operation by the update detecting server 102 and the update detecting server 212. With regard to the information registration operation in the detection target managing server 202, which is similar to that in the Web page update detection system 1 in the first embodiment, the explanation thereof will be omitted. Although the update detecting server 102 can be arranged in all of the intranets 100-1 to 100-n, the operation of the update detecting server 102 belonging to the intranet 100-2 will be described as a representative of this embodiment.

[Update Notification Operation]

The update detecting server 102 in the intranet 100-2 starts up regularly to access the detection target managing server 202. Since the information stored in the detection target managing server 202 includes personal information on each user, it is preferable to use a protocol with a security function added for communication between the update detecting server 102 and the detection target managing server 202.

The update detecting server 102 creates a list of URL to be the update detection target for every user code registered. Since the update detecting server 102, at this time, belongs to the intranet 100-2, the update detecting server 102 creates a list including a record including a group code “G002” assigned to the intranet 100-2 and including URL related to a domain “where02.com” of the intranet 100-2. In the case of data shown in FIG. 2, records (7)-(10) correspond thereto. The update detecting server 102 accesses the WWW server 108 belonging to the same network (intranet 100-2) in accordance with this list to confirm the update state of the Web page specified by the user.

The update detecting server 102 stores all source files of the Web page accessed first in the cache while creating difference data from the cache data on the Web page which has ever been accessed to update the cache data. Any method is applicable to create the difference data.

The update detecting server 212 on the Internet 500 performs an update detecting operation, in conjunction with the update detecting operation in the update detecting server 102 in the intranet 100-2, or individually. When in conjunction with each other, it is preferable to adopt the following system, for example.

When the update detecting server 102 belonging to the intranet 100-2 accesses the detection target managing server 202 to perform an update detecting operation, the update detecting server 102 provides the detection target managing server 202 with the information indicating this update detection. The detection target managing server 202 includes an operating condition table including a group code field and an operating condition field as shown in Table 1, for example, in order to store this information.

TABLE 1

| group code | operating condition |
|---|---|
| G001 | 0 |
| G002 | 1 |
| G003 | 0 |
| . | . |
| . | . |
| . | . |
| G009 | 0 |

When the update detecting server 102 belonging to the intranet 100-2 (group code “G002”) performs an update detecting operation, “1” is written into the operating condition field corresponding thereto in the operating condition table. The update detecting server 212 on the Internet 500 confirms the content of operating condition table and extracts a group code with an operating condition flag “1” (here, G002). Then the update detecting server 212 creates a list including a record including the group code extracted from the database shown in FIG. 2 and including URL which is not related to the domain “where02.com” of the intranet 100-2. In the case of data shown in FIG. 2, records (4)-(6), (11) and (12) correspond thereto. The update detecting server 212 accesses the WWW servers 300-1 to 300-m on the Internet 500 in accordance with this list to confirm the update state of the Web page specified by the user. The update detecting server 212 detects the update of Web page and rewrites the operating condition flag in the operating condition table in the detection target managing server 202 from “1” to “0”.

Adopting this system makes it possible to make the update detecting server 212 and the update detecting server 102 perform update detecting operation at the same time. In addition, it is applicable to send a start-up signal directly from the update detecting server 102 to the update detecting server 212 without interposing the detection target managing server 202. Although only the update detecting server 102 belonging to the intranet 100-2 specified by the group code “G002” starts up in the example of Table 1, when each update detecting server belonging to a plurality of intranets starts up in parallel each operating condition flag becomes “1”. In this case, the update detecting server 212 on the Internet 500 creates a list for a plurality of group codes with operating condition flag “1” respectively to perform update detecting operation for the Web page in accordance with each list.

Thus, when the update detecting server 102 and the update detecting server 212 detect the update state of Web page of the URL to be the update detection target and which is related to a certain user code in conjunction with each other or individually, the update detecting server 102 and the update detecting server 212 send the detection result to an e-mail address related to this user code. At this time, the update detecting server 102 and the update detecting server 212 may send the detection result individually, or send the result collected to either thereof (for example, the update detecting server 102). In the former, the user receives two e-mails while in the latter the user receives one e-mail. Note that the update detecting server 102 and the update detecting server 212 can detect the update of Web page and send the update detection result to each e-mail address for a plurality of user codes in parallel.

According the Web page update detection system 2 in the second embodiment, as described above, the same effect can be obtained as in the Web page update detection system 1 in the first embodiment.

In the Web page update detection system 2 in the second embodiment, the Web page stored in the WWW server 108 arranged in each of the intranets 100-1 to 100-n is cached by the update detecting server 102 arranged in the same intranets 100-1 to 100-n. The Web page stored in the WWW servers 300-1 to 300-m on the Internet 500 is cached by the update detecting server 212 arranged on the Internet 500. Therefore, the data on Web page provided only to the inside of each of the intranets 100-1 to 100-n can be prevented from leaking onto the Internet 500 to prevent leakage of confidential information. Further, the copies of same Web page are not stored in a plurality of caches, which improves efficiencies of data management and update detecting operation.

Although the preferred embodiment of the present invention has been described referring to the accompanying drawings, the present invention is not restricted to such examples. It is evident to those skilled in the art that the present invention may be modified or changed within a technical philosophy thereof and it is understood that naturally these belong to the technical philosophy of the present invention.

1. An information update detection system comprising: an update detection target managing means arranged at an external network and managing a storage place of one or more pieces of internal information stored in an internal information storing means arranged at an internal network with an access from the external network limited; and
an update detecting means arranged at an internal network and detecting an update state of the one or more pieces of internal information the storage place of which is managed by the update detection target managing means.

2. An information update detection system according to claim 1 further comprising a charging means for calculating a fee based on the number of storage place of the internal information managed by the update detection target managing means.

3. An information update detection system according to claim 1 wherein the update detection target managing means manages a user code assigned to each user and manages the storage place of the internal information in units of the user code.

4. An information update detection system according to claim 3 further comprising a charging means for calculating a fee, based on one of the number of storage place of the internal information and the number of the user code which are managed by the update detection target managing means, or based on a combination thereof.

5. An information update detection system according to claim 3 wherein: the update detection target managing means manages one or more notified parties for every user code; and
the update detecting means detects the update state of the internal information and notifies the notified party of a corresponding detection result.

6. An information update detection system according to claim 5 further comprising a charging means for calculating a fee, based on one of; the number of storage place of the internal information, the number of the user code, and the number of the notified party, which are managed by the update detection target managing means, or based on a combination of two or more thereof.

7. An information update detection system according to claim 1 wherein: the update detection target managing means manages a storage place of one or more pieces of external information stored in an external information storing means arranged at an external network; and
the update detecting means detects the update state of the one or more pieces of external information the storage place of which is managed by the update detection target managing means.

8. An information update detection system according to claim 1 wherein the internal network is intranet and the external network is the Internet.

9. An information update detection system according to claim 1 wherein the internal information storing means is WWW server.

10. An information update detection system according to claim 7 wherein the internal information storing means and the external information storing means are WWW server.

11. An information update detection system comprising: an update detection target managing means arranged at an external network, managing a storage place of one or more pieces of internal information stored in an internal information storing means arranged at an internal network with an access from the external network limited and managing a storage place of one or more pieces of external information stored in an external information storing means arranged at the external network;
an internal update detecting means arranged at an internal network and detecting an update state of the one or more pieces of internal information the storage place of which is managed by the update detection target managing means; and
an external update detecting means arranged at an external network and detecting an update state of the one or more pieces of external information the storage place of which is managed by the update detection target managing means.

12. An information update detection system according to claim 11 further comprising a charging means for calculating a fee based on one of the number of storage place of the internal information and the number of storage place of the external information which are registered in the update detection target managing means or based on a combination thereof.

13. An information update detection system according to claim 11 wherein the update detection target managing means manages a user code assigned to each user and manages the storage places of the internal information and the external information in units of the user code.

14. An information update detection system according to claim 13 further comprising a charging means for calculating a fee, based on one of; the number of storage place of the internal information, the number of storage place of the external information, and the number of user code, which are registered in the update detection target managing means, or based on a combination of two or more thereof.

15. An information update detection system according to claim 13 wherein: the update detection target managing means manages one or more notified parties for every user code; and
the internal update detecting means detects the update state of the internal information and notifies the notified party of a corresponding detection result; and
the external update detecting means detects the update state of the external information and notifies the notified party of a corresponding detection result.

16. An information update detection system according to claim 15 further comprising a charging means for calculating a fee, based on one of; the number of storage place of the internal information, the number of storage place of the external information, the number of the user code, and the number of the notified party, which are registered in the update detection target managing means, or based on a combination of two or more thereof.

17. An information update detection system according to claim 11 wherein the internal network is intranet and the external network is the Internet.

18. An information update detection system according to claim 11 wherein the internal information storing means and the external information storing means are WWW server.
